(19) United States
(12) Patent Application Publication
(10) Pub. No.: US 2006/0054754 A1
(43) Pub. Date: Mar. 16, 2006

(54) Expandable stand

(76) Inventors: Paul L. Liberman, Fayetteville, NY (US); Kevin John Roy McGowan, St. Peters, MO (US)

Correspondence Address: CHASE LAW FIRM L.C, 4400 COLLEGE BOULEVARD, SUITE 130, OVERLAND PARK, KS, 66211, US

(21) Appl. No.: 10/939,899

(22) Filed: Sep. 13, 2004

(51) Int. Cl. F16M 11/00

(52) U.S. Cl. 248/172; 248/174; 108/153.1

(57) ABSTRACT

An expandable stand is provided to accommodate televisions of different sizes. The expandable stand includes a fixed frame to support the television, shelves for electronic components or other items, an expandable top, front panels which are sized to match the width of the expandable top, and a rear panel which may include a box to hide electrical wires and cables.

### FIELD OF THE INVENTION

The present invention generally relates to furniture and, more particularly, to a television stand which may be expanded to accommodate many differently sized televisions.

### BACKGROUND OF THE INVENTION

Televisions come in many different sizes. Varying screen sizes and shapes and chassis sizes necessitate different television stand sizes to accommodate each of the differently sized televisions. A manufacturer of television stands must produce several different sizes and must be aware of new television screen and chassis sizes and configurations offered by the television manufacturers. Additionally, a retailer of television or television stands must stock many different stands for the different television models. If a television model is discontinued, the retailer and manufacturer of the corresponding television stand may be left with excess television stands. Manufacturers and retailers may offer universal or “one-size-fits-all” television stands which avoid the problem of stocking many differently sized television stands and the associated risk of having a surplus of obsolete television stands. However, the customer who buys a universal stand often must settle on an ill-fitting stand that doesn't match the television.

### SUMMARY OF THE INVENTION

The present invention provides a television stand which is expandable to accommodate differently sized televisions to provide a custom fit stand for the television. The stand includes a fixed top and an expandable top which are attached to a frame. The expandable top may be adjusted to match the size of the television. A horizontal front panel is sized to match the width of the expandable top and is attached to the frame. A horizontal front panel is sized to match the width of the expandable top and vertical leg panels. Additional horizontal front panels may be included to create numerous widths matching the intervals of the expandable top and vertical leg panels. Vertical leg panels are aligned with the horizontal front rail and expandable top and attached to the frame. Vertical leg panels are also adjustable matching the intervals of the expandable top. One or more shelves may be included with the stand along with a wire management system which hides the electrical wires and cables of electronic components such as VCRs, DVD players, receivers and speakers which may be set on the shelves and interfaced with the television or other components.

### BRIEF DESCRIPTION OF THE DRAWINGS

FIG. 1 is a perspective view of the expandable stand of the present invention showing ranges of expansion.

FIG. 2 is an exploded perspective view of the frame components of the expandable stand of FIG. 1.

FIG. 3 is a perspective view of an assembled frame of FIG. 2.

FIG. 4 is an exploded perspective view of the expandable top, horizontal front rails and vertical leg panels and the frame of FIG. 3.

FIG. 5 is an exploded perspective view of a cable management component.

### DETAILED DESCRIPTION

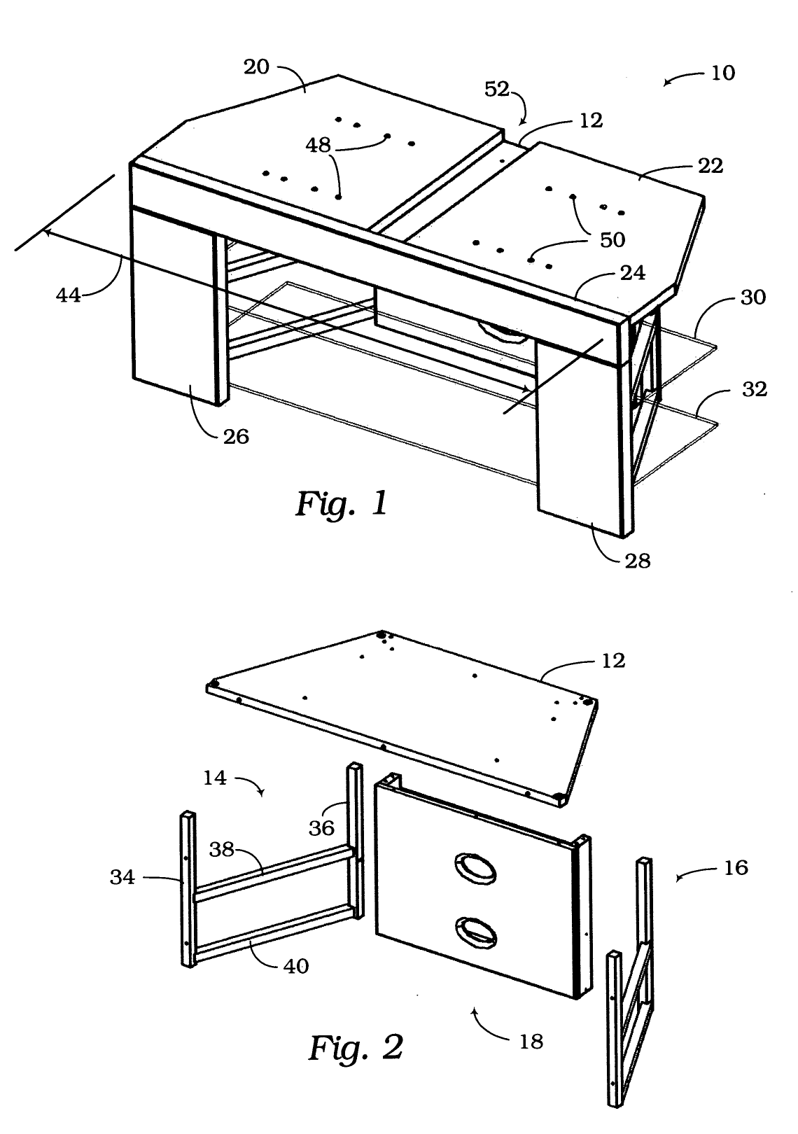

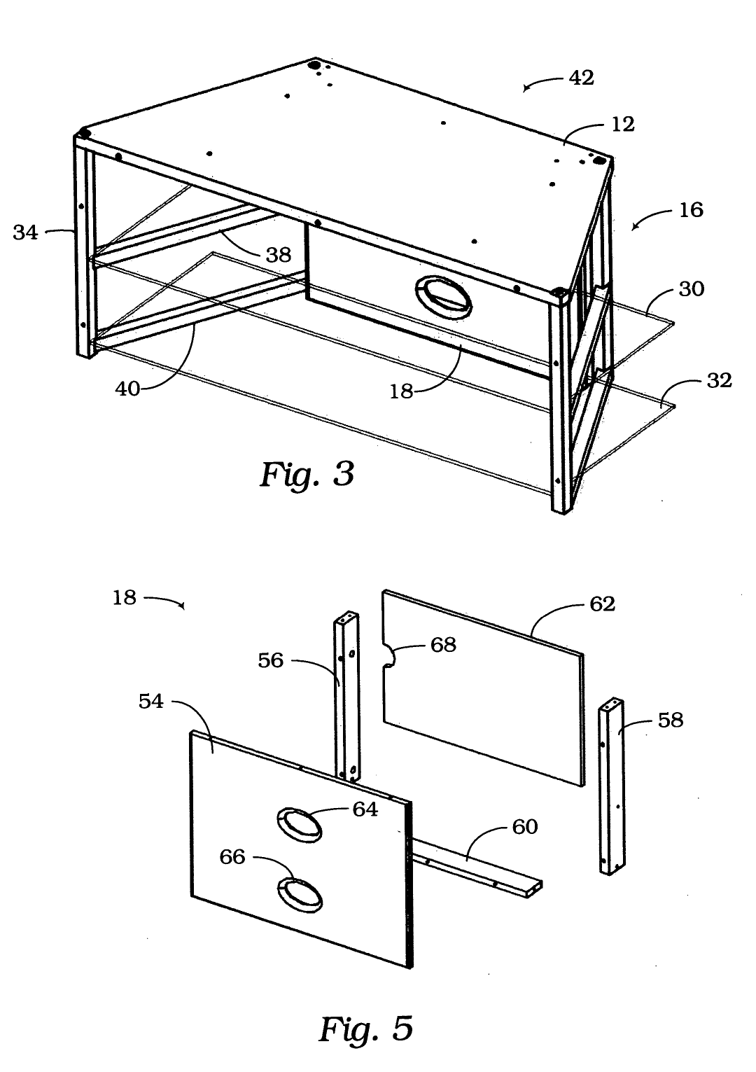

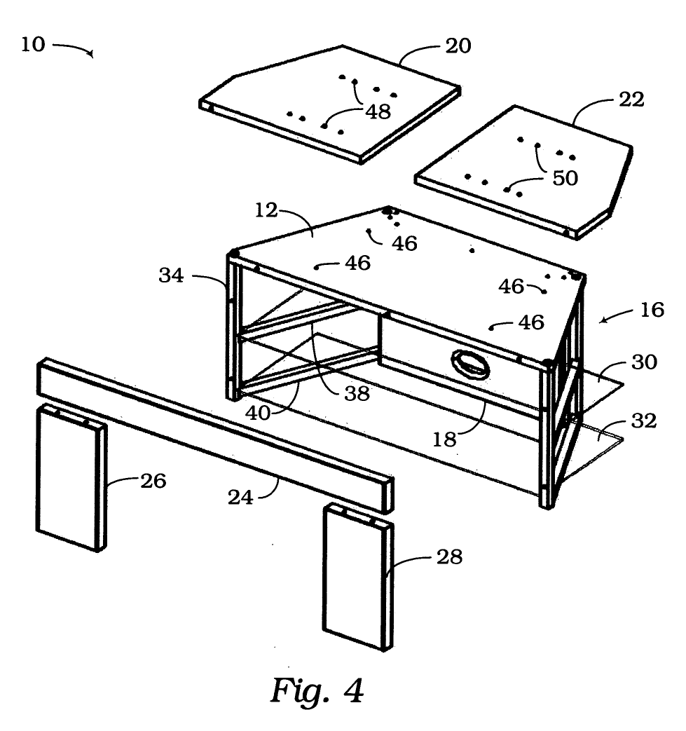

Referring to FIGS. 1-4, the expandable stand of the present invention is generally indicated by reference numeral 10. Expandable stand 10 includes a fixed top 12, side frame members 14 and 16, a back panel 18, left and right expandable top members 20 and 22, a horizontal front panel 24, vertical leg panels 26 and 28, and shelves 30 and 32.

Fixed top 12 generally has a trapezoid shape to generally match the shape of a chassis of a television (not shown). Fixed top 12 may be made of any suitable material such as a composition wood sheet, plywood, or synthetic material, for example.

Side frame members 14 and 16 include identical components and thus will be described only for side frame member 14. Side frame member 14 includes a pair of upright legs 34 and 36 and horizontal rails 38 and 40. Upright legs 34 and 36 and horizontal rails 38 and 40 may be constructed of square or round steel or aluminum tubing, for example, and may be welded, bolted or otherwise fastened together to form the rigid side frame member 14. The rear upright leg 36 is fastened to the back panel 18. The fixed top is secured to the upright legs 34 and 36 of each frame member 14 and 16 at the corners and to the back panel 18 using screws or other fasteners, for example, to form the base frame generally indicated by reference numeral 42. Base frame 42 is a rigid, sturdy frame which may be structurally sufficient to support a broad range of television sizes and weights.

The expandable top members 20 and 22 may be attached to the fixed top 12 using screws or other fasteners. The width of the top (indicated by dimension 44) is adjusted to match the width of a television (not shown) before the expandable top members 20 and 22 are secured to the fixed top 12. Fixed top 12 may include pre-drilled holes 46. Expandable top members 20 and 22 may include two rows of a plurality of pre-drilled holes 48 and 50, respectively. The rows are spaced apart to match the front to rear spacing of the holes 46 in the fixed top 12. The individual holes in the rows of holes 48 and 50 are laterally spaced at predetermined intervals which correspond to the standard widths of television, such as 28″, 32″, 36″, 42″, 46″, 50″, 61″, for example, to name a few.

After the width of the television to be used with the expandable stand 10 is determined, the expandable top members 20 and 22 may be secured to the fixed top 12 at a matching width 44 corresponding to the width of the television. The horizontal front panel 24 may be cut to the same width 44 and secured to the front of the frame 42 flush with the top surface of the expandable top members 20 and 22 to hide the gap 52 between the members 20 and 22. A plurality of horizontal front panels 24 may be provided with the expandable stand 10, one of each corresponding to a standard width of a television such as 28″, 32″, 36″, 42″, 46″, 50″ and 61″, for example, so that the horizontal front panel 24 does not have to be cut to size to match the width 44 of the expandable top members 20 and 22. The vertical leg panels 26 and 28 may be secured to the upright legs 34 of the side frame members 14 and 16, respectively, using screws or other fasteners. Side frame members 14 and 16 may include pre-drilled holes. Vertical leg panels may include two rows of a plurality of pre-drilled holes. The two rows of holes are spaced at predetermined intervals which correspond with the expandable top intervals. Glass shelves 30 and 32 may be placed across the horizontal rails 38 and 40 to support other electronic components (not shown), for example.

Referring to FIG. 5, back panel 18 may be configured to hide wires and cabling of any electronic components situated on the shelves 30 and 32. Back panel 18 includes a front panel 54, sides 56 and 58, a bottom panel 60, and a removable rear panel 62. When assembled together the members of the back panel 18 form an open-top box. Front panel 54 includes upper 64 and lower 66 apertures which are spaced to be above the shelves 30 and 32. Wires and cabling from electronic components and equipment may be passed through the apertures 64 and 66 so that the wires are hidden from view from the front of the expandable stand 10. Removable rear panel 62 includes a notch 68 through which electrical cords may be passed to provide power to the components and which may be used to open the removable rear panel 62. When all of the components and the television are wired together, all of the wires may be arranged in the back panel 18 and the removable rear panel 62 put in place to hide the wires from view.

Having thus described the invention, what is claimed as new and desired to be secured by Letters Patent is as follows:

1. An expandable stand for supporting a television comprising:
a frame having a top, a pair of opposed side members, and a rear member,
a pair of opposed expandable top members secured to said frame top and having a width corresponding to the width of said television,
a front horizontal panel secured to said frame and having a length corresponding to said width of said pair of opposed expandable top members, and
a pair of vertical leg panels, each secured to one of said pair of opposed side members.

2. The expandable stand of claim 1 wherein said side members each includes an at least one horizontal rail.

3. The expandable stand of claim 2 further comprising a shelf extending between said side members and resting on said horizontal rails.

4. The expandable stand of claim 3 wherein said rear member includes a front panel, side panels, a bottom panel and a back panel presenting a hollow box, said front panel having an aperture spaced generally above said shelf and extending into said box.

5. The expandable stand of claim 4 wherein said back panel includes a notch in an edge of said back panel.

6. An expandable stand for supporting a television comprising:
a frame having a top, a pair of opposed side members, and a rear member,
a pair of expandable top members adjustably secured to said top and positionable at a width corresponding to the width of said television,
an at least one shelf extending between and supported by said pair of opposed side members,
a pair of vertical leg panels each secured to one of said pair of opposed side members, and
a horizontal panel secured to said frame above said vertical legs having a length corresponding to said width of said expandable top members.

7. The expandable stand of claim 6 wherein said rear member includes a front panel, side panels, a bottom panel and a back panel presenting a hallow box, said front panel having an aperture spaced generally above said shelf and extending into said box.

8. The expandable stand of claim 7 wherein said back panel includes a notch in an edge of said back panel.

9. An expandable stand for supporting a television comprising:
a frame having a top, a pair of opposed side members, and a rear member,
a pair of expandable top members adjustably secured to said top and positionable at a width corresponding to the width of said television,
an at least one shelf extending between and supported by said pair of opposed side members,
a pair of vertical leg panels each secured to one of said pair of opposed side members, and
a horizontal panel secured to said frame above said vertical legs having a length corresponding to said width of said expandable top members,
wherein said rear member includes a front panel, side panels, a bottom panel and a back panel presenting a hallow box, said front panel having an aperture spaced generally above said shelf and extending into said box,
wherein said back panel includes a notch in an edge of said back panel.
